(19) United States
(12) Patent Application Publication
(10) Pub. No.: US 2018/0268264 A1
(43) Pub. Date: Sep. 20, 2018

(54) DETECTING ANOMALOUS SENSOR DATA

(71) Applicant: HEWLETT PACKARD ENTERPRISE DEVELOPMENT LP, Houston, TX (US)

(72) Inventors: Manish Marwah, Palo Alto, CA (US); Aniket Chakrabarti, Columbus, OH (US); Martin Arlitt, Calgary (CA)

(21) Appl. No.: 15/543,745

(22) PCT Filed: Jan. 28, 2015
(86) PCT No.: PCT/US2015/013303

§ 371 Date: Jul. 14, 2017

(51) Int. Cl. G06K 9/62; H04L 29/06

(52) U.S. Cl. CPC G06K 9/6297; H04L 63/1425; G06K 9/623

(57) ABSTRACT

A technique that includes predicting data acquired by a network of sensors based at least in part on a graphical model of the network, where the graphical model includes true value nodes, observed value nodes and edge factors based at least in part on historical pairwise dependencies for the observed value nodes. The technique includes detecting anomalous sensor data based at least in part on the predicted data.

### BACKGROUND

The decreasing cost of sensors has led to their deployment in large numbers for such purposes as monitoring and managing infrastructure and resources. Data acquired by sensors may be monitored to detect problems with the sensors, such as hardware failure, for example.

### BRIEF DESCRIPTION OF THE DRAWINGS

FIG. 1 is a schematic diagram of a sensor-based system according to an example implementation.

FIG. 2 is an illustration of a sensor model building process according to an example implementation.

FIGS. 3 and 4 are illustrations of Markov Random Field (MRF)-based graphical model topologies according to example implementations.

FIG. 5A is a flow diagram depicting a technique to use a model of a sensor network to detect anomalous sensor data according to an example implementation.

FIGS. 5B and 6 are flow diagrams depicting techniques to derive MRF-based graphical models for sensor networks according to example implementations.

FIG. 7 is a schematic diagram of a physical machine according to an example implementation.

### DETAILED DESCRIPTION

Sensor data may be processed for purposes of detecting one or multiple outliers, or anomalies, in the sensor data so that corrective action may be taken to repair, reconfigure, replace or remove (as examples) the affected sensor(s) that are identified as providing anomalous data (i.e., data that represents an outlier). The anomaly detection may be beneficial for such purposes as identifying abnormal conditions that may result from errant operation of a sensor, such as a failure (or impending failure) of a sensor, a misconfiguration of a sensor or malicious activity involving a sensor.

One way to detect a failed sensor is to use threshold-based outlier detection in which a sensor value (provided by the sensor) is compared to a threshold. Another way to detect outliers is to model a network of sensors as being a statistical model and use sensor values that are predicted by the model to identify outliers. Such a statistical model may be especially beneficial for a sensor network that has a relatively large number (hundreds or even tens of million, for example) of sensors.

In accordance with example techniques and systems that are disclosed herein, a statistical model is used to model a network of sensors, which takes into account a global dependency structure of the sensor network to predict sensor values for the network (assuming the network is properly functioning). The predicted sensor values, in turn, may be used to identify anomalous sensor data (i.e., outlier sensor data). In this manner, the predicted sensor values may compared to the observed sensor values to identify any outliers. A particular advantage in the use of a global dependency structure-based model for outlier detection is that the model may be relatively more precise and robust in the presence of outliers and missing sensor values than a model that is based only on local dependencies among the sensors. Moreover, the global dependency structure-based model allows detection of anomalous sensor data, which may not be achievable using a threshold-based outlier detection method, in which a sensor value is merely compared to a predetermined threshold level, or using a model that is based on local features or variables.

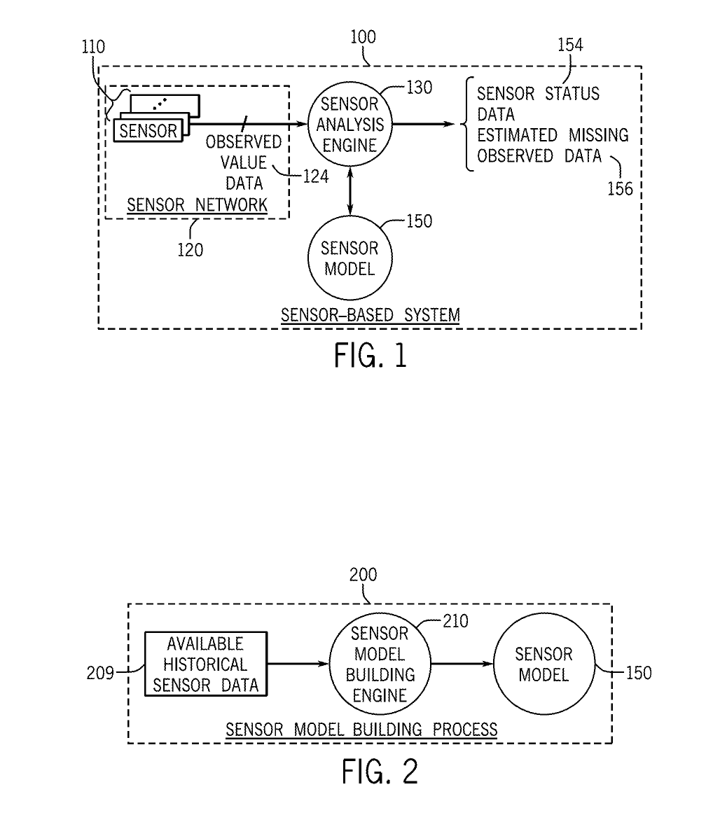

Referring to FIG. 1, in accordance with example implementations, a sensor-based system 100 includes a sensor network 120, which includes a relatively large number of sensors 110 (hundreds to tens of millions of sensors, for example). The sensor network 120 may be used for a variety of purposes, such as, for example, in the transportation industry, where vehicle fleet management is aided by the continuous acquisition of data by sensors that are attached to vehicles. In this regard, in this application, the sensor network 120 may acquire data that may be monitored and processed for such purposes as aiding vehicle maintenance, optimizing vehicle routes, promoting driver safety, and so forth.

As another example, the sensor network 120 may be used in a smart building, where the sensors 110 measure such parameters as air temperature, humidity, building occupancy, lighting, and so forth, for purposes of managing heating, ventilation, air conditioning and lighting systems and optimizing the use of resources, such as electricity, gas and water.

As yet another example, the sensor network 120 may be used in a utility infrastructure, where the sensors 110 acquire data that monitor power, water, and so forth for efficient resource management.

For such purposes as ensuring proper operation of the sensor network 120 and estimating, or predicting, missing sensor data, the system 100 includes a sensor analysis engine 130. In general, sensor analysis engine 130 monitors observed value data 124, i.e., data acquired by the sensors 110, for purposes of detecting outliers, or anomalies, in the sensor data. In this regard, a given sensor 110 may provide anomalous data due to errant operation of the sensor, such as (as examples) the failure of the sensor 110, the impending failure of the sensor 110, errant operation of the sensor 110 due to its misconfiguration, and errant operation of the sensor 110 due to malicious activity involving the sensor 110 or sensor network 120.

In accordance with example techniques and systems that are disclosed herein, the sensor analysis engine 130 uses a sensor model 150 for purposes of recognizing anomalous sensor data. As described herein, the sensor model 150, in accordance with example implementations, predicts the behavior of a proper functioning sensor network and takes into account global dependencies among the sensors 110. In particular, in accordance with example implementations, the states of the sensors 110 are modeled using random variables of an undirected graphical model; and in accordance with some example implementations, the sensor model 150 is a Markov Random Field (MRF)-based graphical model.

In accordance with example implementations, the sensor analysis engine 130 monitors the observed value data 124 and uses the sensor model 150 to generate sensor status data 154, which identifies any individual sensor(s) 110 that are providing anomalous data so that the appropriate corrective action may be taken for the affected sensor(s) 110. For example, the affected sensor(s) 110 may be replaced, repaired, reconfigured, and so forth. Moreover, in accordance with example implementations, the sensor analysis engine 130 may also use the sensor model 150 for purposes of providing estimated missing observed data 156 for any failed sensor(s) 110 or any sensor(s) 110 in which communication with the sensor(s) 110 has otherwise failed.

Referring to FIG. 2 in conjunction with FIG. 1, in accordance with example implementations, the sensor model 150 is constructed in a model building process 200 in which a sensor model building engine 210 constructs the sensor model 150 from available “historical” sensor data 209. In accordance with example implementations, the “historical” sensor data 209 is observed value data, which has been acquired at a previous time and is available offline. For example, the sensor network 120 may be a network of sensors, and the corresponding available historical sensor data 209 may be acquired sensor data from weather stations, which indicates, or represents, the observed temperatures in association with the time of day, the pressure, the humidity, the wind speed, and so forth. Thus, for this example, the weather stations may include at least sensors to sense temperature, pressure, humidity and wind speed. These parameters, as an example, may be recorded on an hourly basis or at other sampling periods.

As noted above, in accordance with example implementations, the sensor model 150 may be a Markov Random Field (MRF)-based graphical model. In general, an MRF graphical model is an undirected probabilistic graphical model that contains nodes, which are interconnected by edges: each node of the graphical model represents a random variable, and the edges represent the dependencies among the random variables. The dependencies associated with the edges are referred to as “edge factors” herein. An MRF graphical model may explicitly represent the interdependencies in the joint distribution of all of the random variables, which helps to model the underlying statistical processes.

In accordance with example implementations, an MRF-based graphical model in which each edge factor represents the dependencies between a pair of random variables, or nodes, may be used to model the sensor network 120.

The joint distribution of all of the random variables may be factorized into the product of the pairwise edge factors. More specifically, assuming there are n random variables in the MRF graphical model, “E” represents the edge set, ϕᵢⱼ represents the pairwise edge factor between nodes xᵢ and xⱼ, and Z represents the partition function, then the joint distribution (called “P( )”) may be described as follows:

$$P ( {x}_{1} , {x}_{2} , … {x}_{n} ) = \frac{1}{Z} {\prod }_{i , j ∈ E} {φ}_{ij} ( {x}_{i} , {x}_{j} ) . \qquad Eq . 1$$

In general, the systems and techniques that are described herein use the above-described pairwise edge factor dependencies for purposes of determining the edge factors for the sensor model 150.

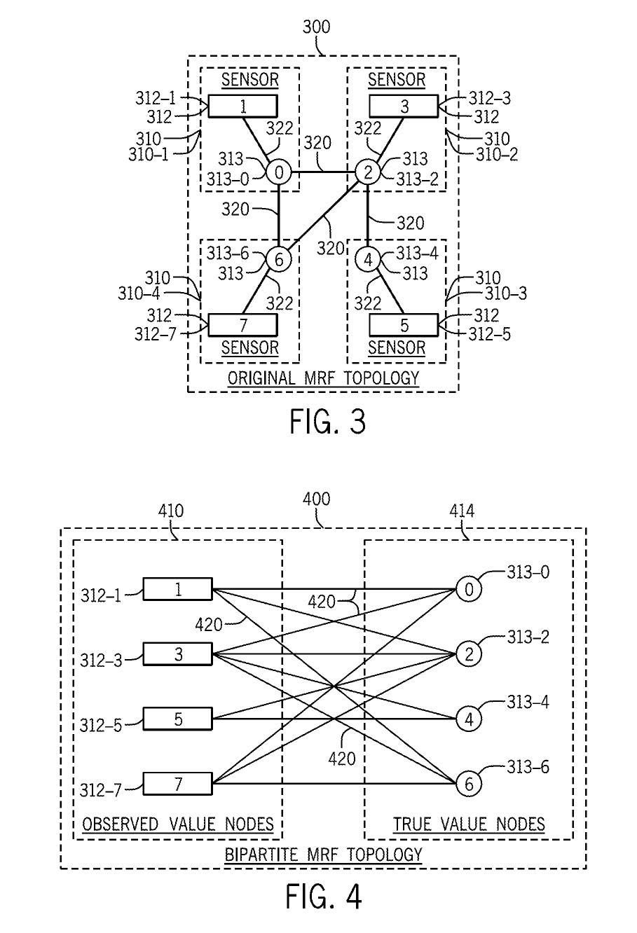

As an example implementation, the sensor model 150 may (at least in the initial stages of building the model, as described herein) have a pairwise MRF topology 300 that is depicted in FIG. 3. Referring to FIG. 3 in conjunction with FIGS. 1 and 2, each sensor 310 (four example sensors 310-1, 310-2, 310-3 and 310-4, being depicted in FIG. 3) is represented by two nodes: an observed value node (represented by the square-shaped node 312) and a hidden, true value node (represented by the circle-shaped node 313). For the example implementation of FIG. 3, eight nodes are used to represent the four sensors 310-1, 310-2, 310-3 and 310-4. In this context, a “true value node” is a node that provides what is predicted by the model 150 as being the correct, or true, value for the associated sensor; and a “observed value node” is a node that provides the data acquired (and provided) by the associated sensor. These eight nodes include four true value nodes 313 (true value nodes 313-0, 313-2, 313-4 and 313-6) and four observed value nodes 312 (observed value nodes 312-1, 312-3, 312-5 and 312-7).

As a more specific example, the sensor 310-1 has an associated observed value node 312-1 and an associated true value node 313-0. As another example, the sensor 310-3 has an associated observed value node 312-5 and an associated true value node 313-4. The values for the true value nodes 313-0, 313-2, 313-4 and 313-6 are “hidden” because the values for the true value nodes 313 are hidden, or unknown, from the historical data 209. It is noted that some of the values for the observed value nodes 312 may also be hidden, in that the corresponding observed values may not be available from the historical data 209.

Due to each sensor 310 being represented by two nodes (an observed value node 312 and a true value node 313), each sensor 310 is hence represented by two random variables in the MRF graphical model.

In accordance with example implementations, the sensor model building engine 210 (FIG. 2) discretizes the historical data 209. For example, in accordance with example implementations, the sensor model building engine 210 may apply fixed width binning to discretize the domain of the historical data 209 into a finite number of intervals. For example, the sensor model building engine 210 may create sixteen possible states for the node attributes. Because each node may assume one of the sixteen states, a pair of nodes may report 16×16=256 jointly occurring states. In other words, for this specific example, the dependency score vector has a length of “256.”

In accordance with example implementations, the sensor model building engine 130 uses the available, observed sensor data to construct a dependency graph, which identifies any dependencies between pairs of the sensors 310. It is noted that dependencies may not exist for every sensor pair. In accordance with example implementations, if the dependency graph identifies a dependency between two sensor nodes in the dependency graph, the sensor building engine 130 adds an edge 320 between the corresponding true value nodes 313 in the MRF topology 300.

More specifically, in accordance with example implementations, for each sensor pair, the sensor model building engine 210 determines the frequencies of co-occurring observations for the pair using the historical data; and the engine 210 normalizes the frequencies, such as normalizing the frequencies to a scale that spans from “0” to “1,” for example.

The normalized frequency for a given co-occurring observation may be called a “dependency score.” In accordance with example implementations, for each sensor pair, a corresponding vector of dependency scores is produced. If the maximum value in the dependency score vector exceeds a certain threshold, then, in accordance with example implementation, the engine 210 adds an edge 320 between the corresponding true value nodes 313. Otherwise, in accordance with example implementations, the sensor model building engine 210 does not add an edge between the true value nodes 313.

In accordance with further example implementations, the dependency score may be determined using a different metric. For example, in place of a co-occurrence frequency, correlation or mutual information may be used. As another example, instead of comparing the maximum value of a dependency score vector to a threshold, a median or average value derived from the vector may be compared to a threshold. Thus, many variations are contemplated, which are within the scope of the appended claims.

In accordance with example implementations, the edge factor for the edge 320 is the dependency score vector between the pair of sensor nodes. For example, if the observed sensor nodes 312-1 and 312-3 have a given dependency score vector, then, in accordance with example implementations, that dependency score vector is used as the edge factor for an edge 320 between the corresponding true value nodes 313-0 and 313-2. As another example, for a given dependency between the observed value nodes 312-3 and 312-4, a corresponding edge factor representing the dependency is used, and this edge factor is used as the edge factor for the edge 320 between the true value nodes 313-2 and 313-4.

The above-described edge factor assignment implies that the true states are related according to the learned dependency graph, and the observed state of every sensor 310 depends on the true state of that location. For every sensor node in the original dependency graph, the sensor model building engine 210 also adds an edge 322 between the true value node 313 and the observed value node 312. Thus, if there are N nodes and E edges in the original graph, the MRF topology 300 contains 2N nodes and E+N edges.

In accordance with example implementations, the sensor model building engine 210 may assign a potential, or factor to the edges 320 that extend between the observed value nodes 312 and the true value nodes 313. A relatively high probability (a probability of 0.99 or even 1, for example) may be used, in accordance with example implementations. The factors that are assigned to these edges 320 may be learned from data (if available), in accordance with further example implementations.

In accordance with example implementations, after construction of the MRF topology 300, the sensor building engine 210 may apply a graphical model inference algorithm, (a message passing-based algorithm, such as belief propagation algorithm, a variable elimination algorithm, a Markov chain Monte Carlo (MCMC) algorithm, a variational method, and so forth) for purposes of determining the states for hidden node values. There may be a relatively large number of values, which may be hidden. In this manner, none of the values for the true value nodes 313 are available, in accordance with example implementations, and possibly a relatively large number of observed node values may be unavailable, or hidden, as well. The goal of the graphical model inference algorithm is to infer states of the hidden nodes. In accordance with example implementations, the sensor model building engine 210 runs graphic model inference on the MRF topology 300 until convergence occurs.

In accordance with further example implementations, the model building engine 210 may transform the original pairwise MRF topology 300 of FIG. 3 into another pairwise MRF topology, called a “bipartite MRF topology 400,” which is depicted in FIG. 4. The bipartite MRF topology 400, in accordance with example implementations, allows faster convergence of graphical model inference algorithms. Moreover, the bipartite MRF topology 400 may have the advantage of preventing the graphical model inference algorithm from settling in local optima.

In general, the bipartite MRF topology 400 groups the nodes 312 and 313 into two groups: a group 410 of the observed value nodes 312; and a group 414 of the true value nodes 313. For the bipartite MRF topology 400, each true value node 313 that was connected to one or more true value nodes 313 (in the original MRF topology 300) is instead connected to one or more observed value nodes. It is noted that in the bipartite MRF topology, no observed value nodes 312 are connected, as in the pairwise MF topology 300. Thus, in the bipartite MRF topology, there are no connections within the group 414 of true value nodes 313 or within the group 410 of observed value nodes 312.

In accordance with example implementations, the graphical model inference algorithm may be a belief propagation algorithm and performing the belief propagation algorithm involves the following steps. First, it is assumed that an MRF-based graph already exists. The observed values for all of the sensors are obtained. There may be a relatively large number of values that may be missing. Moreover, none of the true values may be available, in accordance with example implementations. The nodes for which no value is available are referred to as “hidden nodes” herein. Thus, all of the true nodes and possibly a large number of observed nodes (depending on the amount of missing data) are hidden nodes. The goal of the belief passing is to infer the states of all of the hidden nodes. The belief passing is run on the MRF until convergence. In general, the belief propagation is a message passing algorithm for inference in graphical models, which involve the following steps. First, at each node, messages are read from neighboring nodes, a marginal belief is updated, and update message are sent to the neighbors. The above-described process is repeated until convergence. The values of observed nodes are compared with true nodes.

The sensor analysis engine 130 (FIG. 1), in accordance with example implementations, uses the sensor model 150 to predict the true values for the sensor using the sensor model 150 and compares the true values to the observed values using the sensor model 150. Cases where large discrepancies are present (based on a predefined percentage difference, for example) between the observed and true values are marked as anomalous by the sensor engine 130, and the sensor engine 130 identifies the corresponding affected sensors in the sensor status data 154 (FIG. 1). Moreover, the sensor analysis engine 130 may further use the sensor model 150 to provide the estimated missing observed data 156 for the affected sensors.

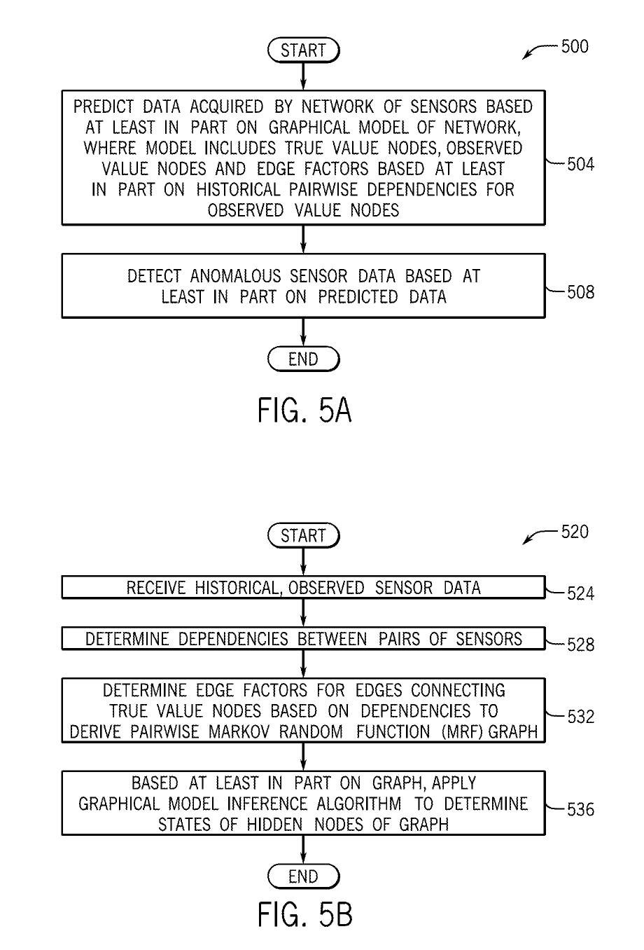

Referring to FIG. 5A, thus, in accordance with example implementations, a technique 500 includes predicting (block 504) data acquired by a network of sensors based at least in part on a graphical model of the network, where the graphical model includes true value nodes, observed value nodes and edge factors based at least in part on historical pairwise dependencies for the observed value nodes. The technique 500 further includes detecting (block 508) anomalous sensor data based at least in part on the predicted data.

Referring to FIG. 5B, to summarize the sensor model building, in accordance with example implementations, a technique 520 includes receiving historical, observed sensor data, pursuant to block 524. Dependencies are determined (block 528) between pairs of the sensors, and edge factors are then determined (block 532) for edges connecting true value nodes based on the dependencies to derive a pairwise Markov Random Function (MRF) graph. Based at least in part on the MRF graph, the technique 520 includes applying a graphical model inference algorithm to determine states of hidden nodes of the graph, pursuant to block 536.

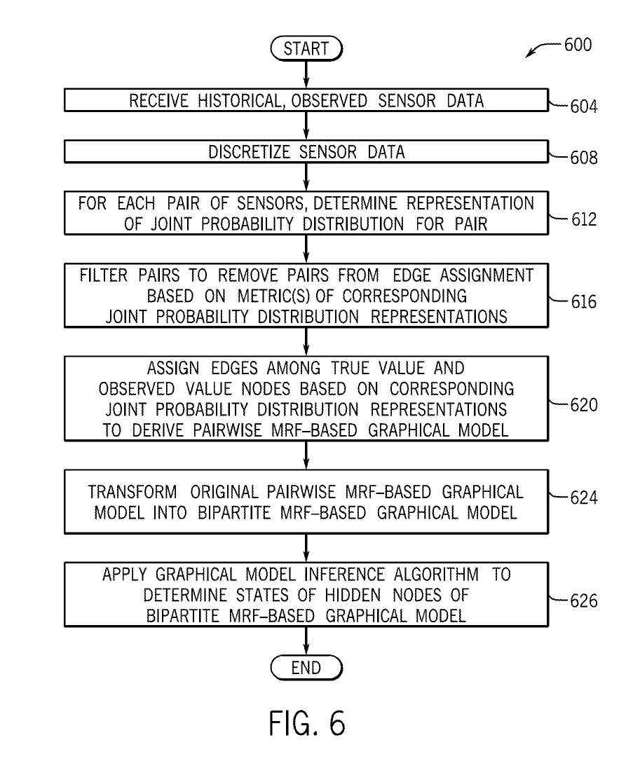

In accordance with some example implementations, the sensor model building engine 210 may perform a technique 600 that is depicted in FIG. 6. Referring to FIG. 6, the technique 600 includes receiving historical, observed sensor data, pursuant to block 604. The sensor data may then be discretized, pursuant to block 608. In this manner, a wide variety of methods may be used for this purpose, such as fixed width binning, fixed frequency binning, a hybrid approach of fixed width and fixed frequency binning, and so forth. For each pair of sensors, the technique 600 includes determining (block 612) a representation of a joint probability distribution for the pair. The pairs are then filtered (block 616) to remove pairs from edge assignment based at least one metric of corresponding joint probability distribution representations. For example, in accordance with some implementations, a frequency threshold may be established. Next, pursuant to block 620, edge factors among the true value and observed value nodes are assigned based on corresponding joint probability distribution representations to derive a pairwise MRF-based graphical model. The original MRF-based graphical model is then transformed (block 624) into a bipartite MRF-based graphical model, pursuant to block 624. A graphical model inference algorithm is then applied (block 626) to determine the states of the hidden nodes of the bipartite-based MRF graphical model.

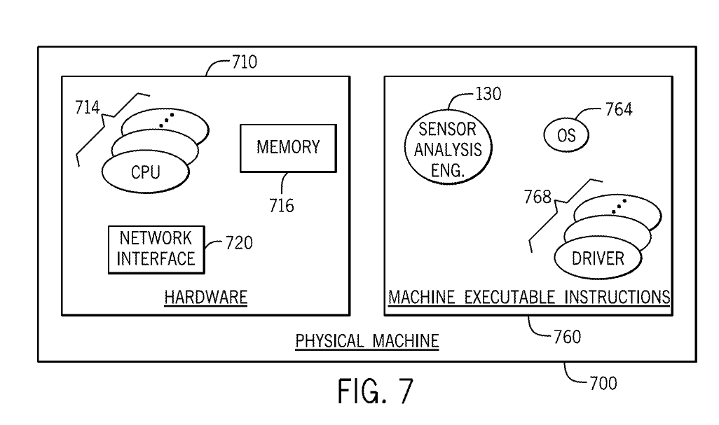

In accordance with example implementations, the sensor analysis engine 130 may be executed by a processor of a processor-based machine, or computer. For example, in accordance with some implementations, a physical machine 700 that is depicted in FIG. 7. The physical machine 700 is an actual machine that includes actual hardware 710 and actual machine executable instructions 760, or “software.”

In general, the hardware 710 may include one or multiple central processing units (CPUs) 714, a non-transitory memory 716 and a network interface 720. As examples, the memory 716 may be formed from semiconductor storage devices, magnetic storage devices, memristors, phase change memory devices, and so forth, depending on the particular implementations. In general, the memory 716 may store machine executable instructions, which are executed by the CPU(s) 714 for purposes of forming one or more components of the machine executable instructions 760. The memory 716 may further store data describing the sensor model 150, as well as other data.

For the example of FIG. 7, the machine executable instructions 760 may be executed to form the sensor analysis engine 130. Moreover, the machine executable instructions 760 may be executed to form other software components, such as an operating system 764, one or more device drivers 768, and so forth. Therefore, in accordance with example implementations, the sensor analysis engine 130 may be a software component, i.e., a component formed by at least one processor executing machine executing instructions, or software. In further example implementations, the sensor analysis engine 130 may be considered a hardware component that is formed from dedicated hardware (one or more integrated circuits that contain logic configured to perform outlier detection, as described herein, for example). Thus, the sensor analysis engine 130 may take on one of many different forms and may be based on software and/or hardware, depending on the particular implementation. A physical machine similar to the physical machine 700 may also be used, in accordance with example implementations, to form the sensor model building engine 210 of FIG. 2. In this regard, for these implementations, one or multiple CPUs may execute instructions stored in a memory, similar to the arrangement of FIG. 7, for purposes of forming the model building engine 210. Therefore, in accordance with example implementations, the sensor model building engine 210 may be a software component, i.e., a component formed by at least one processor executing machine executing instructions, or software. In further example implementations, the sensor model building engine 210 may be considered a hardware component that is formed from dedicated hardware (one or more integrated circuits that contain logic configured to perform outlier detection, as described herein, for example). Thus, the sensor model building engine 210 may take on one of many different forms and may be based on software and/or hardware, depending on the particular implementation.

In further example implementations, the same physical machine may provide the physical platform for both engines 130 and 210. Moreover, the engine 130 and/or 210 may be formed inside a virtual machine of a physical platform in accordance with further example implementations. Thus, many implementations are contemplated, which are within the scope of the appended claims.

While the present techniques have been described with respect to a number of embodiments, it will be appreciated that numerous modifications and variations may be applicable therefrom. It is intended that the appended claims cover all such modifications and variations as fall within the scope of the present techniques.

What is claimed is:

1. A method comprising:
predicting data acquired by a network of sensors based at least in part on a graphical model of the network, the graphical model comprising true value nodes, observed value nodes and edge factors based at least in part on historical pairwise dependencies for the observed value nodes; and
detecting anomalous sensor data based at least in part on the predicted data.

2. The method of claim 1, further comprising:
modeling the network of sensors as a graph containing one of the true value nodes and one of the observed value nodes for each sensor of the network.

3. The method of claim 1, wherein using the model comprises an undirected graphical model.

4. The method of claim 1, wherein the model comprises a Markov Random Field (MRF)-based graphical model.

5. The method of claim 1, further comprising:
determining dependencies between observed pairs of the observed nodes; and
determining the edge factors based at least in part on the determined dependencies.

6. The method of claim 1, further comprising:
determining values for at least some of the true value nodes of the model using a graphical model inference algorithm.

7. The method of claim 1, further comprising:
determining at least one value for at least one of the observed value nodes using a graphical model inference algorithm.

8. An apparatus comprising:
a sensor network comprising a plurality of sensors; and
an engine comprising a processor to use a graph-based model of the sensor network to detect errant operation for at least one sensor of the sensor network, wherein the model comprises a true value node and an observed value node for each sensor of the plurality of sensors, and the model comprises edge factors determined from dependencies between at least some of the observed value nodes exhibited by historical data.

9. The apparatus of claim 8, wherein the sensor network comprises a model based at least in part on a global dependency structure of the sensor network.

10. The apparatus of claim 8, wherein the engine predicts data for at least one of the sensors using the model.

11. The apparatus of claim 8, wherein the model comprises a Markov Random Field (MRF)-based graphical model.

12. An article comprising a computer readable non-transitory storage medium storing instructions that when executed by a computer cause the computer to:
model a network of sensors as a graph containing a true value node and an observed value node for each sensor of the network; and
determine edge factors for edges connecting the true value nodes based at least in part on pairwise dependencies exhibited by historical data acquired by the sensor network.

13. The article of claim 11, the storage medium storing instructions that when executed by the computer cause the computer to:
for each pair of the sensors, determine a representation of a joint probability distribution of observed data for the pair of sensors; and
determine the edge factors based at least in part on the determined joint probability distributions.

14. The article of claim 13, the storage medium storing instructions that when executed by the computer cause the computer to:
filter the determined probabilities based at least in part on at least one joint probability distribution metric; and
determine the edge factors based at least in part on results of the filtering.

15. The article of claim 12, the storage medium storing instructions that when executed by the computer cause the computer to:
model the sensor network as a first pairwise Markov Random Field (MRF) graph;
transform the pairwise MRF graph to a second MRF-based graph; and
apply a graphical model inference algorithm to the second MRF-based graph to determine the states of the hidden nodes.
